(19) United States
(12) Patent Application Publication
(10) Pub. No.: US 2026/0265591 A1
(43) Pub. Date: Sep. 10, 2026

(54) Structural Adhesives Cured By Polycarbonate

(71) Applicant: Zephyros, Inc., Romeo, MI (US)

(72) Inventors: Michael Czaplicki, Romeo, MI (US); Yuan Lu, Romeo, MI (US)

(21) Appl. No.: 19/166,587

(22) PCT Filed: Mar. 20, 2024
(86) PCT No.: PCT/US2024/020682

§ 371 Date: Sep. 18, 2025

Related U.S. Application Data
(60) Provisional application No. 63/453,311, filed on Mar. 20, 2023.

(51) Int. Cl. C09J 163/00; C08G 59/40; C08G 59/62

(52) U.S. Cl. CPC C09J 163/00; C08G 59/4007; C08G 59/621

(57) ABSTRACT

A material adapted for curing and/or foaming comprising (i) one or more epoxy resins, (ii) at least one polycarbonate, and (iii) at least one catalyst, preferably transesterification catalyst for catalyzing reaction of the polycarbonate.

### CLAIM OF PRIORITY

This application claims the benefit of the priority date of U.S. Provisional Application No. 63/453,311, filed Mar. 20, 2023, the contents of that application being hereby incorporated by reference herein in its entirety and for all purposes.

### FIELD OF INVENTION

The present teachings relate generally to adhesives, preferably structural adhesives, cured by transesterification reaction of polycarbonate.

### BACKGROUND

Structural adhesives have been widely used in different industries including automotive, aerospace, wind energy, marine, and other industrial sectors. These adhesives provide alternatives to mechanical fastening, allowing for more flexible product design and use of new materials for light weighting and sustainability. One-component heat activatable adhesives contain latent curatives and are activatable by heat to initiate polymer advancement and subsequent polymerization or crosslinking. Common latent curatives include dicyandiamide, urea, hydrazide, boron trifluoride amine complex, acid anhydrides, and other related compounds. Nitrogen-containing curatives often generate ammonia or amine by-products with strong odor when the adhesive is being cured at the elevated temperatures.

The United Nations Economic Commission for Europe has been promoting its guidance on car interior air quality standards aiming to reduce the interior odor. Other organizations are interested in solving the odor issue as well, particularly in Asia where complaints concerning unpleasant odors or harmful emissions in car's interiors seem to be especially prevalent. As the car interior air quality regulation has been adopted by more and more automotive manufacturers in Europe and Asia, there is a demand for materials that meet this requirement, with particular difficulty associated with chemical systems that are reactive, such as adhesives and sealants.

In the automotive industry, heat activated foaming sealants with reduced odor created during the reaction process have been developed by introducing foaming agents that create minimal ammonia byproducts. Likewise, structural adhesives with nitrogen-containing curatives are facing the same challenge and may require replacements to comply with car interior air quality regulation. As such, a different curing mechanism without odor generating byproducts is desired.

Polycarbonate (PC) has been found to react with other materials including epoxide and hydroxyl/phenol via transesterification mechanism. The present teachings, therefore, seek to provide structural adhesives cured by presumed polycarbonate transesterification in the absence of common heat activatable curatives including dicyandiamide, hydrazide, acid anhydride, and boron trifluoride amine complex. Additionally, PC transesterification curing mechanism may lead to properties unachievable by traditional curing reactions.

### SUMMARY OF INVENTION

The teachings herein are directed to a material comprising one or more epoxy resins, at least one polycarbonate, and at least one catalyst for the reaction between the one or more epoxy resins and the at least one polycarbonate. The material is an adhesive, preferably a one-component adhesive.

The adhesive may contain polyol and/or phenols.

The adhesive may contain a moisture scavenger, flexibilizers, and/or polymeric core shell particles.

The adhesive may have an expansion (volume expansion) from 0% to 100%, when cured at 140-200° C. for at least 30 minutes.

The adhesive may be in the form of pumpable materials, tapes, and/or injection moldable adhesives.

It is possible to produce products with a wide range of desirable physical properties using polycarbonate transesterification curing.

A high-modulus adhesive may be produced having a lap shear strength greater than 30 MPa when determined in accordance with ASTM D5868 with 50.4 mm/min crosshead speed and 0.25 mm bondline, and a tensile modulus greater than 1100 MPa, determined in accordance with ASTM D638 with 5 mm/min crosshead speed, when cured at 162.8° C. for 30 minutes.

An elastomeric adhesive may be produced having a strain-to-failure greater than 50% (determined in accordance with ASTM D638 with 5 mm/min crosshead speed) when cured at 162.8° C. for 30 minutes.

A non-expandable adhesive may be produced having a T-peel strength of at least 5 N/mm when determined with 254 mm/min crosshead speed and 0.25 mm bondline, and a lap shear strength of at least 30 MPa when determined in accordance with ASTM D5868 with 50.4 mm/min crosshead speed and 0.25 mm bondline, when cured at 162.8° C. for 30 minutes.

An expandable adhesive may be produced having a T-peel strength of at least 4 N/mm when determined with 254 mm/min crosshead speed and 0.25 mm bondline, and a lap shear strength of at least 14 MPa when determined in accordance with ASTM D5868 with 50.4 mm/min crosshead speed and 0.25 mm bondline, when cured at 140-200° C. for at least 30 min.

The adhesive may comprise polycarbonate in the range of about 5% to about 60% by weight relative to the total weight of the adhesive.

The adhesive may comprise a catalyst in the range of about 0.01% to about 10% by weight relative to the total weight of the adhesive.

The adhesive may comprise a moisture scavenger in the range of about 0% to about 40% by weight relative to the total weight of the adhesive.

The adhesive may comprise a flexibilizer in the range of about 0% to about 40% by weight relative to the total weight of the adhesive.

The adhesive may comprise a polymeric particle in the range of about 0% to about 30% by weight relative to the total weight of the adhesive.

The polycarbonate resins may have a melt index ranging from about 2 to about 60 g/10 min (300° C., 1.2 kg load) and molecular weight from about 5,000 to about 300,000 Daltons.

The polyol may be aliphatic or aromatic polyester or polyether or polycarbonate polyols.

Phenols may include hydroquinone, resorcinol, catechol, various diphenol including bisphenol A, bisphenol F, bisphenol E, bisphenol AP, bisphenol Z, bisphenol M, bisphenol P, bisphenol G, bisphenol BP, novolac phenols or any combination thereof.

The catalyst for the reaction between the one or more epoxy resins and the at least one polycarbonate may include quaternary ammonium salts, quaternary phosphonium salts, Lewis acids, metal oxides, phosphines, solid strong acids, or any combination thereof. The moisture scavenger may include calcium oxide, molecular sieves, vinyltrimethoxy silane, zeolite, oxazolidines, or any combination thereof.

The flexibilizer (or flexibilizer in an adduct with epoxy) may be selected from, phenol terminated urethane, fatty dimer acid/epoxy adduct, polyetheramine (Jeffamine® products available from Huntsman for example)/epoxy adduct, Epoxonic 328 (e.g., a di-carboxyl functional modifier) (available from Epoxonic GmbH) or any combination thereof.

The polymeric particle may include core modifiers of polybutadiene, styrene-butadiene rubber, or a combination thereof. The polymeric particle may include core/shell rubber particles averaging about 100-200 nm in size, and may be free of agglomerated particles.

The adhesive may include one or more particulate and/or fiber components, which may be selected from silica, diatomaceous earth, glass, clay (e.g., including nanoclay), glass beads or bubbles, glass, carbon or ceramic fibers, nylon, aramid or polyamide fibers (e.g., Kevlar), pyrophyllite, sauconite, saponite, nontronite, wollastonite, montmorillonite, or any combination thereof.

The adhesive may include a silica and/or calcium-based reinforcement component. The adhesive may include a silica-based rheological modifier comprising fumed silica.

### BRIEF DESCRIPTION OF THE DRAWINGS

FIG. 1 shows characterization of polycarbonate transesterification by measurement of carbonate peak shift in a FTIR spectrum.

### DETAILED DESCRIPTION

The explanations and illustrations presented herein are intended to acquaint others skilled in the art with the present teachings, its principles, and its practical application. The specific embodiments of the present teachings as set forth are not intended as being exhaustive or limiting of the present teachings. The scope of the present teachings should be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

Percentages herein refer to weight percent, unless otherwise indicated.

Unless expressly stated otherwise, the terms “material” and “adhesive” are used interchangeably. Thus, the material according to the invention is the adhesive according to the invention.

Unless expressly stated otherwise, the terms “epoxy resin” and “epoxy” are used interchangeably.

Unless expressly stated otherwise, the terms “polycarbonate resin” and “polycarbonate” are used interchangeably.

Unless expressly stated otherwise, molecular weight of polymeric species is preferably expressed as weight average molecular weight (Mw), preferably determined by GPC.

Unless expressly stated otherwise, all references to standards such as ASTM preferably refer to the version that is officially valid on Jan. 1, 2024.

Melt index is preferably determined in accordance with ASTM D1238.

T-peel strength is preferably determined in accordance with ASTM D1876.

The material of the present teachings may be applied to various articles of manufacture for adding structural integrity to portions or members of the articles. Examples of such articles of manufacture include, without limitation, household or industrial appliances, furniture, storage containers, buildings, structures, or the like. The material may be applied to portions of transportation vehicles including boats, trucks, trains, airplanes, automotive vehicles, or the like. The material may be utilized in an automotive vehicle, such as with body or frame members (e.g., a vehicle frame rail) of the automotive vehicle.

The present teachings are directed to the use of a transesterification reaction process to cure heat-activated compositions including structural adhesives in the absence of common nitrogen-containing curatives such as dicyandiamide, hydrazide, and boron trifluoride amine complex. Exclusion of the above-mentioned curatives enables creation of structural adhesives with minimal odor both prior to, during, and after cure. Examples of transesterification include heat-activated reaction of polycarbonate with epoxide and/or hydroxyl/phenol in the presence of the catalyst, which may be a transesterification catalyst.

Polycarbonates (e.g., polycarbonate resins) are a family of thermoplastic polymers characterized by high strain-to-failure combined with high strength, stiffness, and impact resistance. They have not traditionally been used in thermosetting compositions. They contain carbonate groups in its chemical structure which are known to react with epoxies, polyols, and phenols by transesterification reactions. Such transesterification can be catalyzed by suitable catalysts.

The present teachings are directed to demonstrate the use of these reactions as crosslinking mechanisms for epoxy-based heat-activated structural adhesives, which may be one-component epoxy-based heat activated structural adhesives. The present teachings also aim at revealing key factors for altering the adhesive properties (i.e., lap shear strength, peel strength, strain-to-failure, and foaming percentage (if any)) with polycarbonates as curatives.

The material may include at least one type of polycarbonate resin with a melt index ranging from about 3 to about 35 g/10 min (300° C., 1.2 kg load) and molecular weight from about 10,000 to about 100,000 Daltons. Non-limiting examples of polycarbonate resins that may be used are Lexan™ from Sabic, Hylex™ from Ravago Manufacturing Americas, CALIBRE™ from Trinseo, and TRIREX™ from Samyang Corporation. The polycarbonate may be included in a percentage of up to about 50% by weight relative to the total weight of the material.

The content of the polycarbonate resin may be approximately at least about 2% by weight, more typically at least about 10% by weight, more typically at least about 20% by weight relative to the total weight of the material. It may be approximately about 50% or less by weight, more typically about 40% or less by weight, more typically about 30% or less by weight, and even more typically 25% or less by weight relative to the total weight of the material. In order to enhance the compounding of the adhesive, it is preferred that the polycarbonate resin be combined with other composition constituents as a solution. While any solvent may be used to decrease incorporation temperature during mixing, it is particularly preferred to use a low molecular weight epoxy resin as the solvent so that the solvent can react into the adhesive composition upon activation.

The material described herein may include an epoxy resin, to react with polycarbonate by transesterification to form the polymeric matrix of the adhesive. Both liquid and solid epoxy resins may be used in combination to tune the viscosity of the material. Exemplary epoxy resins may be DER 331 from Olin Corporation, Epotec™ YDF 172LV (DGEBF), available from Aditya Birla and DER 664 from Olin Corporation. An epoxy resin may also be added to the material to increase the adhesive properties and flexibility of the material. A silane-modified epoxy resin may aid in allowing the material to adhere to non-ferrous metals, such as to aluminum, as well as improving adhesion after environmental exposure (i.e., humidity, salt spray). The silane-modified epoxy resin may be reaction product between at least one epoxy resin and a silane compound. An example of a suitable silane-modified epoxy resin is Epokukdo™ KSR-177 (di-functional silane-modified epoxy resin) available from Kukdo Chemical. Suitable flexible epoxy resins include Epiol™ DE202 from Kukdo Finechem Co., Ltd. and DER 732 from Olin Corporation. Various mixtures of several different epoxy resins may be employed to achieve desirable properties for an intended purpose.

The content of the epoxy resin may be approximately at least about 20% by weight, more typically at least about 30% by weight, more typically at least about 40% by weight relative to the total weight of the material. It may be approximately about 80% or less by weight, more typically about 70% or less by weight, more typically about 60% or less by weight, and even more typically 50% or less by weight relative to the total weight of the material.

The material may include a difunctional or multifunctional polyol or phenol, which reacts with both epoxy resins and polycarbonate at high temperatures in the presence of the catalyst, which may be a transesterification reaction.

Difunctional phenols act as chain extenders for epoxy resins, leading to longer chain length and thus greater possibility of achieving a composition capable of deforming plastically. They have been found useful to improve adhesive peel resistance as a result of the longer chain oligomers reducing cross-link density. Although polyols and phenols are not necessary to produce crosslinking epoxy resins, they may be used as bridging molecules to link epoxy to polycarbonate due to the reactivity to both materials, consequently leading to higher crosslinking density and glass transition temperature. Examples of polyols include aliphatic and aromatic polyester, polyether, and polycarbonate polyols, such as Resonance aliphatic and aromatic polyols from Bakelike™ and Eternacoll™ polyols from UBE Industries Ltd. Example phenols include hydroquinone, resorcinol, catechol, bisphenol A, bisphenol F, bisphenol E, bisphenol AP, bisphenol Z, bisphenol M, bisphenol P, bisphenol G, bisphenol BP, and other related compounds. Polyphenols with functionality greater than two may also be used to improve crosslinking density for high temperature performance. Exemplary polyphenols include Tannin, Ellagic acid, Theaflavin-3-gallate, and phenolic resin.

The content of polyols and phenols may be approximately at least about 1% by weight, more typically at least about 5% by weight, more typically at least about 10% by weight relative to the total weight of the material. It may be approximately about 30% or less by weight, more typically about 25% or less by weight, more typically about 20% or less by weight, and even more typically 15% or less by weight relative to the total weight of the material.

A catalyst may be used to activate the transesterification of polycarbonate to aid in sufficient crosslinking. Reaction partners in the transesterification reaction with the polycarbonate can be the one or more epoxy resins and/or the optionally present one or more polyols and/or phenols. Quaternary ammonium salts, quaternary phosphonium salts, phosphines, Lewis acids, metal oxides, and solid strong acids may be suitable catalysts for this reaction.

Examples of quaternary ammonium and phosphonium salt may be tetraethylammonium bromide, tetrabutylammonium bromide, tetramethylammonium chloride, tetraethylphosphonium chloride, tetrabutylphosphonium chloride, and other related compounds. The catalyst may also be quaternary ammonium functionalized fillers such as Garamite-treated nano-clay products by BYK and quaternary ammonium functionalized ion exchange resin such as Dowex™ strong base resin available from DuPont. The catalyst may also be phosphines like triphenylphosphine, trinaphthylphosphine, or tritolylphosphine. Examples of Lewis acid catalysts include SnCl₄, Si(OEt)₃(CH₂)₂SnCl₃, TiCl₄, TiCl₃, Ti(O-isopropyl)₄, Cp₂TiCl₂, SmI₂, VOCl₃, AlCl₃, dimethyltin dithioglycolate, dibutyltin dilaurate, dioctyltin dithioglycolate, and related materials. Metal oxides that may be utilized include TiO₂, TiO₂/SiO₂, PbO, PbO/MgO, PbO/SiO₂, PbO-r-Al₂O₃, PbO/TiO₂, MoO₃, MoO₃/Al₂O₃, MoO₃/CaO, MgO, Mg₆Fe(OH)₁₆CO₃, Mg—Al-hydrotalcite, and/or SnO₂. Solid strong acids that may be included are sulfonated inorganic filler or ion exchange resins including Amberlyst™ and Amberlite™ materials available from DuPont and Dowex™ products from Lenntech.

The catalyst may be present in an amount approximately at least about 0.02% by weight, more typically at least about 0.1% by weight, more typically at least about 0.2% by weight relative to the total weight of the material. It may be approximately about 10% or less by weight, more typically about 5% or less by weight, and even more typically about 2% or less by weight relative to the total weight of the material.

The material described herein may further include a moisture scavenger. In addition to improving the green state (uncured) humidity resistance, moisture scavengers in the present teachings hinder moisture from participating in the polycarbonate decomposition pathway by thermal hydrolysis and/or aminolysis. Due to the lack of primary and secondary amines in the materials of the present teachings which are known polycarbonate decomposition initiators, polycarbonate is predicted to mainly decompose via thermal hydrolysis. Carbon dioxide is one of the products of this decomposition reaction, which can cause the material to foam upon heat activation. For applications where foaming is not desirable, moisture scavengers may be added to minimize foaming or porosity of the material. Examples of suitable moisture scavengers include calcium oxide, molecular sieves, vinyltrimethoxy silane, zeolite, and oxazolidines.

To minimize foaming, moisture scavengers may be included in an amount of approximately at least about 1% by weight, more typically at least about 7% by weight, more typically at least about 15% by weight relative to the total weight of the material. It may be approximately about 30% or less by weight, more typically about 25% or less by weight, more typically about 20% or less by weight, and even more typically 15% or less by weight relative to the total weight of the material. For applications where spanning a gap is important, moisture scavengers can be excluded to ensure high volume expansion, as the presence of water in the composition will act as a blowing agent to increase volume expansion.

A flexibilizer may be included in the material to improve properties such as strain-to-failure and peel resistance. The use of the term flexibilizer can relate to a single flexibilizer or a combination of multiple different flexibilizers. Although other flexibilizers may be employed, preferred flexibilizers include polymers that are epoxy modified, urethane-modified or any combination thereof. It is believed that when a polyurethane flexibilizer is included the material may reduce stiffness, increase strain-to-failure, and substantially maintain impact strength (e.g., impact resistance) at low temperatures, all while minimizing the reduction of glass transition temperature (Tg) (e.g., as compared to other flexibilizers). Examples of a preferred flexibilizer may be a phenol-terminated urethane based flexibilizer, Rez-Cure® EP 1820 (available from Innovative Resin Systems) and DY965 from Huntsman.

Examples of other preferred flexibilizers are epoxy terminated polyethers or amine precursors to produce epoxide terminated polyethers, such as JEFFAMINE™ M series or SD series, commercially available from Huntsman (polyetheramine/epoxy adducts). Flexibilizers based on cashew nutshell liquid such as the epoxidized liquids Cardolite™ NC-514 and Cardolite™ Lite 2513 HP are also useful flexibilizers. Another example of flexibilizer is Epoxonic™ 328 (e.g., a di-carboxyl functional modifier) adduct with epoxy. All of the individual flexibilizers discussed herein may be used separately or in combination with each other in the material of the present invention, unless otherwise stated. Other examples of a preferred flexibilizer are HyPox™ DA323 (DGEBA and dimer fatty acid adduct) available from Emerald Performance Materials and Epokukdo™ YD-172 by Kukdo Chemical Co., Ltd.

Typically, the content of the flexibilizer is less than 50%, more typically less than 35% and even possibly less than 20% by weight relative to the total weight of the material, although higher and lower values may also be possible unless otherwise stated.

Generally, it is preferable for the material to include at least one type of polymeric particle. Such polymeric particles may be utilized to improve fracture toughness (G_{1C}), peel resistance, and impact resistance. As used herein, the term “polymeric particle” is defined as a particle comprising a polymeric material. Like with any other ingredients of the present teachings, the term “polymeric particle” can include one or more polymeric particles. Various polymeric particles may be employed in the practice of the present teachings and often include one or more elastomers.

It is generally preferable for the polymeric particles to be at least 2%, more typically at least 3%, even more typically at least 6%, still more typically at least 10% and even still more typically at least 20% by weight of the material and also preferable for the polymeric particle to be less than 90%, more typically less than 40% an even more typically less than 30% by weight of the material, although higher or lower amounts may be used in particular embodiments.

Examples of useful polymeric particles include but are not limited to those sold under the tradename, Kane Ace™, commercially available from Kaneka Americas Holding, Inc, Clearstrength™ from Arkema, and Paraloid™ from Dow. Particularly preferred grades of Kane Ace™ are sold under the designations MX-134 and MX-267. The polymeric particles may average no less than 50 nm and no greater than 300 nm in size.

Epoxy functionalized elastomer may be present in the range of about 1% to about 40% by weight relative to the total weight of the material. The elastomer is often a product of epoxy resins and elastomers selected from, carboxyl-terminated butadiene-acrylonitrile (CTBN), amine-terminated butadiene-acrylonitrile (ATBN), carboxylated nitrile rubber (XNBR) and polysulfide or any combination thereof.

The material may include one or more constituents that are discrete from the remaining polymeric matrix and do not melt in normal compounding or processing (e.g., discrete constituents). Discrete constituents are organic or non-organic additives which differ from the polymeric matrix to improve adhesive properties, change thixotropic properties, improve moisture resistance, and/or reduce cost. These may include: silicates such as those sold under the trade names of Garamite™ and Satintone™ clays, mica, talc, clays, wollastonite under the trade names of Nyglos™, Vansil™ and Wollastocoat™, calcium carbonate, calcium oxide, calcium sulfate, fumed silica under trade names of Aerosil™ and Cab-o-sil™, hollow glass and polymer spheres, carbon black, barium sulfate, and graphite.

Other additives, agents, or performance modifiers may also be included in the material as desired, including but not limited to a UV resistant agent, a flame retardant, a heat stabilizer, a colorant, a processing aid, a lubricant, or the like.

It is contemplated that most nearly any additional chemicals, materials, or otherwise, may be added to the material assuming they are suitable for the material and suitable for a chosen application of the material and do not compromise the latency of single component materials.

It is possible that the specific combination and relative amounts of one or more materials described herein, may assist in providing improved values for one or more of T-peel strength, or lap shear strength. As an example, the combination of a polyetheramine/epoxy adduct, core shell particles, and urethane flexibilizer are useful for high T-peel strength. With optimal ratios of these three ingredients, T-peel strength of approximately at least 9 N/mm may be achieved when determined with 254 mm/min crosshead speed and a 0.25 mm bondline. Synergistic effects of these ingredients can be explained by the combination of phase separation toughening, matrix flexibilization, capability of local plastic deformation, and internal strength reduction. For instance, core shell particles and urethane flexibilizer can form phase separated or separating domains for toughening while the polyetheramine/epoxy adduct improves the flexibility and local deformation of the adhesive matrix.

Certain adhesive materials formed in accordance with the present teachings have exhibited strain-to-failure greater than about 2%, greater than about 10%, and even possibly greater than about 100% when determined in accordance with ASTM D638 Type IV test method with 5 mm/min crosshead speed. The strain-to-failure was measured by using an extensiometer to record the deformation that is then used to calculate the material strain.

Certain adhesive materials formed in accordance with the present teachings have exhibited lap shear strength greater than about 10 MPa, greater than about 30 MPa, and even possibly greater than 40 MPa when determined in accordance with ASTM D5868 with 50.4 mm/min crosshead speed and 0.25 mm bondline.

Certain materials formed in accordance with the present teachings have exhibited T-peel strength greater than about 5 N/mm, greater than about 7 N/mm, and even possibly greater than 8.5 N/mm when determined with 254 mm/min crosshead speed and 0.25 mm bondline.

Certain adhesive materials formed in accordance with the present teachings have exhibited glass transition temperature (Tg) of greater than 20 degrees Celsius, greater than 70 degrees Celsius, and even greater than 90 degrees Celsius when determined by ASTM D7028-07. The glass transition temperature determined by this test method (referred to as Dynamic Mechanical Analysis Tg or “DMA Tg”) may not be the same as that reported by other measurement techniques (i.e., peak of tan delta) on the same test specimen. The test method is commonly used to determine upper use temperature for composite materials.

For exemplary purposes, Table A is produced below to illustrate six exemplary formulations for forming the one-component heat activated adhesives cured by a transesterification curing mechanism.

TABLE A

| | #1 | #2 | #3 | #4 | #5 | #6 |
|---|---|---|---|---|---|---|
| Calcium oxide | 9.65 | 7.46 | 11.8 | 11.16 | 13.84 | |
| Dimer fatty acid adduct | 5.79 | | | | | |
| Core shell particles | 6.69 | 4.1 | 6.49 | 6.14 | 7.72 | 4.43 |
| Urethane flexibilizer | 3 | 6.22 | 9.84 | 9.3 | 11.7 | 6.72 |
| Jeffamine ™/epoxy adduct | | 12.44 | | 9.3 | 11.7 | 13.44 |
| Polycarbonate | 14.55 | 21.45 | 14.75 | 13.95 | 6.14 | 23.18 |
| Bisphenol A type liquid epoxy resin | 17.78 | | | | | |
| Bisphenol F type liquid epoxy resin | 23.23 | 34.55 | 37.77 | 35.72 | 30.97 | 37.33 |
| Hexanediol diglycidyl ether | | | | 4.65 | 5.85 | |
| Bisphenol A type solid epoxy resin | 15.92 | 7.25 | 4.92 | | | 7.84 |
| Bisphenol A | | 6.22 | 13.94 | 9.3 | 11.7 | 6.72 |
| Epoxonic 328 Adducted | 2.9 | | | | | |
| Tetraethylammonium bromide | 0.49 | 0.21 | 0.33 | 0.32 | | 0.23 |
| Tetrabutylphosphonium bromide | | | | | 0.19 | |
| Pigment | 0.10 | 0.10 | 0.16 | 0.16 | 0.19 | 0.11 |
| Total weight | 100 | 100 | 100 | 100 | 100 | 100 |

Properties

| | | | | | | |
|---|---|---|---|---|---|---|
| Expansion (%) | 0 | 0 | 0 | 0 | 0 | 94 |
| T peel strength¹ (N/mm) | 5.4 | 8.6 | 5.0 | 8.8 | 12.4 | 4.2 |
| Lap shear strength² (MPa) | 34.1 | 44.4 | 43.3 | 37.4 | 22.1 | 14.7 |
| Tensile modulus³ (MPa) | 1934 | 1656 | 2097 | 1185 | 202 | 172 |
| Peak stress³ (MPa) | 28.2 | 26.3 | 39.5 | 18.8 | 12.2 | 3.5 |
| Strain-to-failure³ (%) | 2.9 | 3.0 | 2.9 | 14.3 | 290 | 3.3 |
| Tg⁴ (° C.) | 49.7 | 70.6 | 79.6 | 50.2 | 37.5 | 73.9 |
| Tg by peak of tan delta (° C.) | 65.2 | 90.0 | 98.9 | 70.2 | 50.9 | 93.8 |

¹0.030″ EG60, test speed: 254 mm/min, bondline 0.25 mm;
²0.060″ EG60, test speed: 50.4 mm/min, bondline 0.25 mm;
³ASTM D638 Type IV test method with 5 mm/min crosshead speed;
⁴ASTM D7028-07. Cure schedule: 162.8° C. for 30 min.

Materials shown in Table A are one-component heat-activated adhesives with a wide range of properties. Sample 1 is an example of a high strength structural adhesive cured by transesterification between polycarbonate and epoxy resins. The lap shear strength of sample 1 is above 30 MPa and T-peel strength is above 5 N/mm. Samples 2-6 demonstrate how to tune the adhesive properties by incorporating other ingredients or manipulating the ratio of these ingredients. For example, Jeffamine™/epoxy adduct can increase T-peel strength (>8 N/mm) and strain-to-failure (>14%) for samples 2 and 4, respectively. Increased bisphenol A helps to achieve higher Tg (i.e., 80° C.) of sample 3. Reducing the ratio of polycarbonate to epoxy leads to an elastomeric adhesive (i.e., sample 5) with a strain-to-failure of over 290%. Sample 6 with no moisture scavenger (CaO) is a foamed adhesive with a volume expansion of around 100%. These results demonstrate the feasibility of transesterification as a curing mechanism for various structural adhesives.

Notably, sample 5 showed a combination of tensile modulus of above 200 MPa and strain-to-failure of 290%. The modulus of this adhesive is significantly higher compared to a typical dicyandiamide-cured adhesive with the same strain-to-failure. It is typical that to obtain an epoxy adhesive with 290% strain-to-failure that the tensile modulus would be below 5 MPa. Strain-to-failure and tensile modulus have a generally inverse relationship where an increase in one corresponds with a decrease in the other. It is thus a significant challenge to provide simultaneous high strain-to-failure and high elastic modulus. This result reveals one significant benefit of utilizing PC transesterification curing for adhesives that produce high strain-to-failure, relatively high modulus, and consequently superior toughness.

It has been found that different ingredients play important roles in influencing the adhesive and mechanical properties. The comparative examples shown below demonstrate the change in physical properties based upon the inclusion/removal of certain components in the material disclosed herein.

TABLE B

| | #2 | #7 | #8 | #9 | #10 | #11 | #6 |
|---|---|---|---|---|---|---|---|
| Calcium oxide | 7.20 | 7.20 | 7.20 | 7.20 | 7.20 | 7.20 | |
| Core shell particles | 3.96 | 3.96 | 3.96 | 3.96 | 3.96 | | 3.96 |
| Urethane flexibilizer | 6.00 | 6.00 | 6.00 | 6.00 | | 6.00 | 6.00 |
| Jeffamine ™/epoxy adduct | 12.00 | 12.00 | 12.00 | | 12.00 | 12.00 | 12.00 |
| Polycarbonate | 20.7 | | 20.7 | 20.7 | 20.7 | 20.7 | 20.7 |
| Bisphenol F type liquid | 33.34 | 33.34 | 33.34 | 33.34 | 33.34 | 33.34 | 33.34 |
| epoxy resin | | | | | | | |
| Bisphenol A type solid | 7.00 | 7.00 | 7.00 | 7.00 | 7.00 | 7.00 | 7.00 |
| epoxy resin | | | | | | | |
| Bisphenol A | 6.00 | 6.00 | | 6.00 | 6.00 | 6.00 | 6.00 |
| Tetraethylammonium | 0.2 | 0.2 | 0.2 | 0.2 | 0.2 | 0.2 | 0.2 |
| bromide | | | | | | | |
| Pigment | 0.10 | 0.10 | 0.10 | 0.10 | 0.10 | 0.10 | 0.10 |
| Total weight | 96.5 | 75.8 | 90.5 | 84.5 | 90.5 | 92.54 | 89.3 |

Properties

| | | | | | | | |
|---|---|---|---|---|---|---|---|
| Expansion (%) | 0 | 0 | 0 | 0 | 0 | 0 | 94 |
| T peel strength¹ (N/mm) | 8.6 | 3.5 | 4.6 | 3.7 | 2.3 | 3.9 | 4.2 |
| Lap shear strength² (MPa) | 44.4 | 2.3 | 25.5 | 45.6 | 39.5 | 28.5 | 14.7 |
| Tensile modulus³ (MPa) | 1656 | 13 | 544 | 2251 | 2793 | 1766 | 172 |
| Peak stress³ (MPa) | 26.3 | 0.05 | 13.7 | 43.5 | 50.1 | 30.9 | 3.5 |
| Strain to failure³ (%) | 3.0 | 16 | 28.4 | 2.7 | 2.3 | 2.3 | 3.3 |
| Tg⁴ (° C.) | 70.6 | 4.7 | 40.2 | 93.2 | 89.6 | 82.6 | 73.9 |
| Tg by peak of tan delta (° C.) | 90.0 | 32.5 | 56.7 | 108.9 | 104.6 | 101.4 | 93.8 |

¹0.030″ EG60, test speed: 254 mm/min, bondline 0.25 mm;
²0.060″ EG60, test speed: 50.4 mm/min, bondline 0.25 mm;
³ASTM D638 Type IV test method with 5 mm/min crosshead speed;
⁴ASTM D7028-07. Cure schedule: 162.8° C. for 30 min.

Sample 2 is used as the control to show how exclusion of each ingredient affects properties of the respective compositions. Comparison of sample 7 to sample 2 demonstrates that polycarbonate is the key constituent necessary to produce a highly crosslinked network. Exclusion of polycarbonate from sample 2 causes the lap shear strength to drop from above 40 MPa to 2.3 MPa for sample 7. In essence, removing polycarbonate makes the composition no longer a structural adhesive. Inspection of the T-peel strength results of samples 8-11 reveal the synergistic effect of core shell particles, urethane flexibilizer, Jeffamine™/epoxy adduct, and bisphenol A on the peel resistance of the material. Excluding any of these ingredients from sample 2 leads to reduction in T-peel strength, although they could still be considered adhesives. This can be explained by the synergy of plastic nature of the adhesive, phase-separating tougheners, and matrix flexibilization on the toughness of structural adhesives. As polycarbonate decomposes via thermal hydrolysis in the presence of a catalyst to generate carbon dioxide, sample 6 without moisture scavenger CaO foams to 94%, which is the reason for reduced lap shear strength and T-peel strength. For high strength applications, moisture scavengers are preferred to minimize foaming. However, when spanning a gap between substrates, foaming is desirable. CaO may be excluded or reduced to promote foaming and create a high performance foamed adhesive.

TABLE C

| | #2 | #12 | #13 | #14 |
|---|---|---|---|---|
| Calcium oxide | 7.20 | 7.20 | 7.20 | 7.10 |
| Core shell particles | 3.96 | 3.96 | 3.96 | 3.96 |
| Urethane flexibilizer | 6.00 | 6.00 | 6.00 | 6.00 |
| Jeffamine ™/epoxy adduct | 12.00 | 12.00 | 12.00 | 6.00 |
| Polycarbonate | 20.7 | 20.7 | 20.7 | 3.15 |
| Bisphenol F type liquid epoxy | 33.34 | 33.34 | 33.34 | 15.89 |
| resin | | | | |
| Bisphenol A type solid epoxy | 7.00 | 7.00 | 7.00 | 3.00 |
| resin | | | | |
| Bisphenol A | 6.00 | | 6.00 | 6.00 |
| Resonance PM92-500 | | 6.00 | | |
| Tetraethylammonium bromide | 0.2 | 0.2 | | |
| Tetraethylphosphonium bromide | | | 0.20 | |
| Triphenylphosphine | | | | 0.10 |
| Pigment | 0.10 | 0.10 | 0.10 | 0.10 |
| Total weight | 96.5 | 96.5 | 96.5 | 51.2 |
| Properties | | | | |
| Expansion (%) | 0 | 0 | 0 | 0 |
| T peel strength¹ (N/mm) | 8.6 | 4.2 | 4.6 | 11.0 ± 0.6 |
| Lap shear strength² (MPa) | 44.4 | 42.9 | 44.0 | 17.4 ± 0.8 |
| Tensile modulus³ (MPa) | 1656 | 2418 | 2427 | 46 ± 16 |
| Peak stress³ (MPa) | 26.3 | 42.8 | 41.7 | 6.9 ± 1.6 |
| Strain to failure³ (%) | 3.0 | 2.3 | 2.4 | 439 ± 31 |
| Tg⁴ (° C.) | 70.6 | 77.7 | 98.3 | 27.7 |
| Tg by peak of tan delta (° C.) | 90.0 | 99.1 | 117.3 | 45.9 |

¹0.030″ EG60, test speed: 254 mm/min, bondline 0.25 mm;
²0.060″ EG60, test speed: 50.4 mm/min, bondline 0.25 mm;
³ASTM D638 Type IV test method with 5 mm/min crosshead speed;
⁴ASTM D7028-07. Cure schedule: 162.8° C. for 30 min.

Different types of phenols and catalysts have been used as alternatives to bisphenol A and quaternary ammonium salt for the preparation of adhesives cured by transesterification of polycarbonate. Quaternary phosphonium salt and phosphine have proven effective at catalyzing the transesterification reaction. Resonance PM92-500, a high functionality (i.e., f=2.6) phenol, further improves the Tg to approximately 100° C. in comparison to use of bisphenol A, corroborating the hypothesis that phenol contributes to crosslinking the network.

TABLE D

| | #2 | #15 | #16 | #6 |
|---|---|---|---|---|
| Calcium oxide | 7.20 | 3.50 | 1.50 | 0.00 |
| Core shell particles | 3.96 | 3.96 | 3.96 | 3.96 |
| Urethane flexibilizer | 6.00 | 6.00 | 6.00 | 6.00 |
| Jeffamine adduct | 12.00 | 12.00 | 12.00 | 12.00 |
| Polycarbonate | 20.7 | 20.7 | 20.7 | 20.7 |
| Bisphenol F type epoxy resin | 33.34 | 33.34 | 33.34 | 33.34 |
| Bisphenol A type epoxy resin | 7.00 | 7.00 | 7.00 | 7.00 |
| Bisphenol A | 6.00 | 6.00 | 6.00 | 6.00 |
| Tetraethylammonium bromide | 0.2 | 0.2 | 0.2 | 0.2 |
| E6580 Orange powder | 0.10 | 0.10 | 0.10 | 0.10 |
| Total | 96.5 | 93.0 | 90.5 | 89.50 |

Properties

| | | | | |
|---|---|---|---|---|
| Expansion (%) | 0 | 8 | 23 | 94 |
| T peel strength¹ (N/mm) | 8.6 | 7.9 | 7.3 | 4.2 |
| Lap shear strength² (MPa) | 44.4 | 35.8 | 34.5 | 14.7 |
| Tensile modulus³ (MPa) | 1656 | 1244 | 469 | 172 |
| Peak stress³ (MPa) | 26.3 | 19.2 | 9.2 | 3.5 |
| Strain to failure³ (%) | 3.0 | 2.6 | 2.9 | 3.3 |
| Tg⁴ (° C.) | 70.6 | 79.1 | 61.2 | 73.9 |
| Tg by peak of tan delta (° C.) | 90.0 | 98.8 | 82.5 | 93.8 |

¹0.030″ EG60, test speed: 254 mm/min, bondline 0.25 mm;
²0.060″ EG60, test speed: 50.4 mm/min, bondline 0.25 mm;
³ASTM D638 Type IV test method with 5 mm/min crosshead speed;
⁴ASTM D7028-07. Cure schedule: 162.8° C. for 30 min.

Examples shown in Table D demonstrate how volume expansion of the material can be tuned by changing the percentage of moisture scavenger. Samples 16 and 6 with low percentage or no CaO exhibit expansion suitable for gap jumping applications. Sample 16 is a low expanding adhesive (i.e., 23% expansion) exhibiting properties typical of a high-performance structural adhesive (i.e., a lap shear strength of 34.5 MPa and a T-peel strength of 7.3 N/mm). Sample 6 is a high expanding adhesive (i.e., 94% expansion) exhibiting a lap shear strength of 14.7 MPa, higher than what is considered a structural adhesive (i.e., 7 MPa). These results have demonstrated the viability of preparing expandable structural adhesives using transesterification of polycarbonate as the curing mechanism.

CaO is an excellent moisture scavenger due to its reactivity to water to yield calcium hydroxide. Thus, CaO may lose its function of anti-foaming as it turns into calcium hydroxide and loses reactivity to moisture. To determine whether the foaming occurs with moisture exposure, sample 2 is exposed to 85% humidity at 25° C. The adhesive did not show any expansion up to 5 months under this condition.

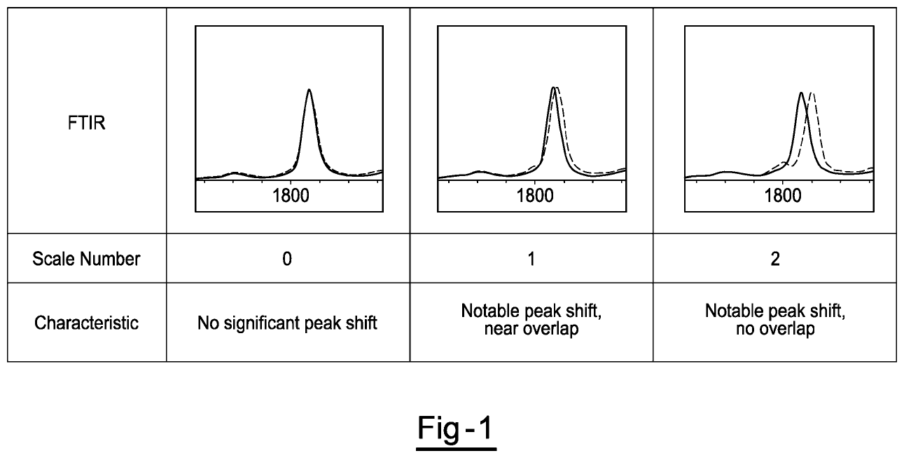

For any latent curative, it is important to have high reactivity at adhesive curing temperature and low reactivity at ambient temperature for storage and transportation. Polycarbonate transesterification occurs only in the presence of proper catalysts. The catalytic reactivity at 325° F. and ambient temperature (i.e., 23° C. and 43° C.) dictates the curing and aging of adhesives cured by polycarbonate transesterification. Ideal catalysts are expected to activate the transesterification at 325° F. for curing but show no catalytic activity at 23 and 43° C. to maintain appropriate shelf-life. As shown in FIG. 1, polycarbonate transesterification can be characterized by carbonate peak shift in a FTIR spectrum. Transesterification to epoxy causes carbonate peak shift to higher wavenumber due to the chemical structural change from aromatic to aliphatic carbonates. As such, catalyst reactivity at 325° F. can be scaled from 0 to 2 according to the extent of carbonate peak shifting. In contrast, catalyst reactivity at ambient temperature is measured by the increase in adhesive viscosity, which is a more sensitive response to low extent of reaction than IR peak shifting.

TABLE E

| | | Viscosity increase | Viscosity increase |
|---|---|---|---|
| | Reactivity | after 3 d at | after 1 month at |
| Catalyst | scale | 43° C. | 23° C. |
| TEABr 0.2 phr | 1 | 30% | 29% |
| TEABr 0.4 phr | 1 | 122% | 76% |
| TBPBr 0.1 phr | 2 | 143% | 11% |
| TBPBr 0.2 phr | 2 | 370% | 222% |
| IATPPBr 0.1 phr | 1 | 75% | 58% |
| IATPPBr 0.2 phr | 1 | 180% | 97% |
| TpTP 0.1 phr | 0 | 182% | 138% |
| TpTP 0.2 phr | 1 | 332% | 228% |

TEABr, Tetraethylammonium Bromide;
TBPBr, Tetrabutylphosphonium Bromide;
IATPPBr, Isoamyltriphenylphosphonium Bromide;
TpTP, Tri(p-tolyl) phosphine

Adhesive formulations composed of 15% polycarbonate, 85% YDF-170 (i.e., bis-F epoxy resin) and various catalysts were used to investigate the reactivity of these catalysts. Adhesives were cured at 325° F. for 30 min. Aging study of uncured adhesives was performed at 23 and 43° C. As shown in table E, catalyst reactivity at 325° F. decreases in the order of TBPBr (high), TEABr and IATPPBr (medium), and TpTP (low). Surprisingly, TpTP also leads to most significant aging at both 23 and 43° C. While low concentration (i.e., 0.1 phr) of TBPBr shows minimal aging at only 23° C., 0.2 phr TEABr and 0.1 phr IATPPBr result in minimal aging at both 23 and 43° C. For DICY cured adhesives, it is typical to have 70-100% viscosity increase after aging at 43° C. for 3 d. Inspection of the results in table E reveals comparable or reduced aging of adhesives cured by polycarbonate transesterification when 0.2 phr TEABr, and 0.1 phr IATPPBr are employed as the catalysts.

As shown in table A, epoxy-based structural adhesives often are composed of various ingredients to affect positively properties including toughness, environmental exposure resistance, and elongation. To ensure minimal adhesive aging, it is also important to incorporate ingredients compatible with polycarbonate curing in a way that they do not activate the polycarbonate transesterification reaction until it is desired for the reaction to occur. Table F shows the viscosity increase of 15% polycarbonate and 85% YDF-170 caused by different ingredients. It is clear that none of these ingredients activate polycarbonate transesterification as indicated by no noticeable viscosity increase.

TABLE F

| | #17 | #18 | #19 | #20 | #21 | #22 | #23 |
|---|---|---|---|---|---|---|---|
| PC (polycarbonate) | 15 | 15 | 15 | 15 | 15 | 15 | 15 |
| Epokukdo ™ YDF 170 | 85 | 85 | 85 | 85 | 85 | 85 | 85 |
| epoxy resin | | | | | | | |
| Urethane toughener | 6 | | | | | | |
| CaO | | 7 | | | | | |
| Aliphatic diacid/epoxy | | | 5 | | | | |
| adduct | | | | | | | |
| CTBN adduct | | | | | | 10 | |
| Core shell particle | | | | 30 | | | |
| dispersion in bisphenol- | | | | | | | |
| A epoxy resin | | | | | | | |
| Jeffamine ™/epoxy | | | | | 5 | | |
| adduct | | | | | | | |
| Core shell particle | | | | | | | 30 |
| dispersion in bisphenol-F | | | | | | | |
| epoxy resin | | | | | | | |
| Fumed silica | 1 | 1 | 1 | 1 | 1 | 1 | 1 |
| Viscosity increase after | 0 | 0 | 0 | 0 | 0 | 0 | 0 |
| 3 d aging at 43° C. | | | | | | | |
| Viscosity increase after | 0 | 0 | 0 | 0 | 0 | 0 | 0 |
| 1 month at 23° C. | | | | | | | |

TABLE G

| | #24 | #25 | #26 |
|---|---|---|---|
| Calcium oxide | 7.1 | 7.1 | 7.1 |
| Fumed silica | | | 1.0 |
| Core shell particles | | | |
| Urethane flexibilizer | 6.00 | 6.00 | 6.00 |
| Jeffamine ™/epoxy adduct | 6.00 | | |
| CTBN adduct | | 6.00 | 6.00 |
| Polycarbonate | 3.15 | 3.15 | 3.15 |
| Bisphenol F type liquid epoxy resin | 19.85 | 19.85 | 19.85 |
| Hexanediol diglycidyl ether | 3.00 | 3.00 | |
| Bisphenol A | 6.00 | 6.00 | 6.00 |
| Tetrabutylphosphonium bromide | 0.10 | 0.10 | 0.10 |
| Pigment | 0.10 | 0.10 | 0.10 |
| Total weight | 51.30 | 51.30 | 49.30 |

Properties

| | | | |
|---|---|---|---|
| Expansion (%) | 0 | 0 | 0 |
| T peel strength¹ (N/mm) | 9.0 | 11.3 | 7.9 |
| Lap shear strength² (MPa) | 11.2 | 15.9 | 27.5 |
| Tensile modulus³ (MPa) | 22 | 44 | 1523 |
| Peak stress³ (MPa) | 5.2 | 6.9 | 18.0 |
| Strain to failure³ (%) | 352 | 358 | 46 |
| Tg⁴ (° C.) | 26.2 | 26.8 | 46.8 |
| Tg by peak of tan delta (° C.) | 43.9 | 43.4 | 62.5 |
| Viscosity increase after 3 d at 43° C. | 25% | 0% | 137% |
| Viscosity increase after 1 month at 23° C. | 25% | 5% | 417% |

¹0.030″ EG60, test speed: 254 mm/min, bondline 0.25 mm;
²0.060″ EG60, test speed: 50.4 mm/min, bondline 0.25 mm;
³ASTM D638 Type IV test method with 5 mm/min crosshead speed;
⁴ASTM D7028-07. Cure schedule: 162.8° C. for 30 min.

Table G shows the properties and aging of formulated adhesives cured by polycarbonate transesterification. Samples 24 and 25 show minimal aging. The viscosity increase is equal to or less than 25% after 3 d at 43° C. and 1 month at 23° C. In comparison to sample 25, sample 26 is an example with exclusion of hexanediol glycidyl ether, which showed more significant increase in viscosity at both 23 and 43° C. This may be a result of the greater ratio of polycarbonate to epoxide. Indeed, there is a positive correlation of adhesive aging and curative concentration. Examples shown in table G demonstrate the feasibility of utilizing polycarbonate transesterification to cure adhesives with minimal aging. Catalyst concentration has been proven to play an important role in maintaining comparable aging to dicyandiamide cured adhesives.

As used herein, unless otherwise stated, the teachings envision that any member of a genus (list) may be excluded from the genus; and/or any member of a Markush grouping may be excluded from the grouping.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time and the like is, for example, from 1 to 90, preferably from 20 to 80, more preferably from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01, or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the of a range in terms of at “‘x’ parts by weight of the resulting polymeric blend composition” also contemplates a teaching of ranges of same recited amount of “x” in percent by weight of the resulting polymeric blend composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist of, or consist essentially of the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

1. A material comprising:
(i) one or more epoxy resins;
(ii) at least one polycarbonate;
(iii) at least one catalyst, preferably a transesterification catalyst
wherein the material is adapted to be cured but free of any additional curing agent beyond the polycarbonate.

2. The material of claim 1, including one or more polyols and/or phenols.

3. The material of claim 2, wherein the catalyst is capable of catalyzing reactions of the at least one polycarbonate with the one or more epoxy resins and/or the one or more polyols and/or phenols.

4. (canceled)

5. (canceled)

6. The material of claim 3, wherein the material has a volumetric expansion of from about 0% to about 100% when cured at 162.8° C. for 30 minutes, but the material is substantially free of any blowing agent beyond the polycarbonate.

7. The material of claim 1, wherein the material is a structural material having a lap shear strength of greater than 30 MPa (determined in accordance with ASTM D5868) and tensile modulus greater than 1100 MPa (determined in accordance with ASTM D638 with 5 mm/min crosshead speed), when cured at 162.8° C. for 30 minutes.

8. The material of claim 1, wherein the material is an elastomeric material having a strain-to-failure greater than 50% (determined in accordance with ASTM D638 with 5 mm/min crosshead speed), when cured at 162.8° C. for 30 minutes.

9. The material of claim 2, wherein the material is non-expandable and has a T-peel strength of at least 5 N/mm (determined in accordance with ISO 11339) and a lap shear strength of at least 30 MPa (determined in accordance with ASTM D5868), when cured at 162.8° C. for 30 minutes.

10. The material of claim 6, wherein the material is an expandable material and has a T-peel strength of at least 4 N/mm (determined in accordance with ISO 11339) and a lap shear strength of at least 14 MPa (determined in accordance with ASTM D5868), when cured at 162.8° C. for 30 minutes.

11. The material of claim 1, wherein the polycarbonate is present in an amount of from about 5% to about 60% by weight relative to the total weight of the material.

12. The material of claim 11, wherein the at least one catalyst is present in an amount of about 0.01% to about 10% by weight relative to the total weight of the material.

13. The material of claim 10, wherein the material comprises one or more moisture scavengers in an amount of from about 0.5% to about 40% by weight relative to the total weight of the material.

14. (canceled)

15. (canceled)

16. The material of claim 3, wherein the at least one polycarbonate has a melt index ranging from about 2 to about 60 g/10 min (300° C., 1.2 kg load) and a molecular weight of from about 5,000 to about 300,000 Daltons.

17. The material of claim 16, including one or more polyols that are aliphatic or aromatic polyester or polyether or polycarbonate polyol.

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. The material of claim 1, wherein the material is substantially free of any dicyandiamide.

32. The material of claim 31, wherein the material has a tensile modulus of greater than 200 MPa (determined in accordance with ASTM D638 with 5 mm/min crosshead speed) and a strain-to-failure of at least 275% (determined in accordance with ASTM D638 with 5 mm/min crosshead speed).

33. (canceled)

34. The material of claim 1, which is a one-component structural adhesive.

35. An adhesive comprising at least:
(i) one or more epoxy resins; and
(ii) at least one polycarbonate;
wherein the adhesive has a tensile modulus of greater than 200 MPa (determined in accordance with ASTM D638 with 5 mm/min crosshead speed) and a strain-to-failure of at least 275% (determined in accordance with ASTM D638 with 5 mm/min crosshead speed).

36. The adhesive of claim 35, including a catalyst for reacting with the at least one poly-carbonate, preferably transesterification catalyst.

37. (canceled)

38. The adhesive of claim 36, wherein the catalyst is capable of catalyzing reactions of the polycarbonate with the one or more epoxy resins and/or the one or more polyols and/or phenols.

39. (canceled)

40. (canceled)

41. (canceled)

42. (canceled)

43. (canceled)

44. The adhesive of claim 35, wherein the adhesive is adapted to cure and optionally to foam but the adhesive is substantially free of any curing or blowing agents beyond the polycarbonate.
